(19) United States
(12) Patent Application Publication
(10) Pub. No.: US 2014/0007491 A1
(43) Pub. Date: Jan. 9, 2014

(54) Use of Vetiver material for reduction, eradication or prevention of bed bugs using various delivery mechanisms for Vetiver oil, powder, dust and carpet into household furnishings, including but not limited to mattress

(71) Applicants: Viken Shah, Carol Stream, IL (US); Manish Shah, Naperville, IL (US); Pinku Shah, Carol Stream, IL (US)

(72) Inventors: Viken Shah, Carol Stream, IL (US); Manish Shah, Naperville, IL (US); Pinku Shah, Carol Stream, IL (US)

(21) Appl. No.: 13/544,293

(22) Filed: Jul. 9, 2012

(51) Int. Cl. A01M 9/00; A01M 7/00

(52) U.S. Cl. 43/132.1

(57) ABSTRACT

Bed Bugs

Cimicidae (referred to as bedbugs) are small parasitic insect. The name “bed bug” is derived from the incest's preferred habitat of houses and especially beds. The most common type is Cimex Lectularius, species that prefer to feed on human blood or the blood of warm-blooded animals. There are numerous health effects due to bed bug. These include skin rashes and allergic symptoms. These nocturnal insects can feed unnoticed on their hosts.

Vetiver

Chrysopogon zizanioides, commonly known as Vetiver, is a perennial grass of the Poaceae family, native to India. In western and northern India, it is popularly known as khus. This grass is known to grow up to 1.5 meters high and forms clumps as wide. Vetiver oil can be extracted from Vetiver roots. Normally, Vetiver is commonly used for cattle feed, aromatherapy, perfumes, soil erosion protection, ropes and handicrafts.

### SUMMARY

This patent covers the use of Vetiver material for reduction, eradication or prevention of bed bugs.

In addition, the patent claims the use of various delivery mechanisms for Vetiver oil, powder, dust and carpet into household furnishings, including but not limited to mattress.

1) The use of Vetiver powder, dust, oil, mat or carpet to prevent, reduce or eradicate bed bugs from Mattress, cushions, pillows, padded seats, cloth and other bedding material. This includes of any Vetiver derived material to prevent, reduce or eradicate bed bugs from household or commercial furniture and furnishings, including but not limited to Mattress, pillows, cushions and seats.

2) Delivery of Vetiver oil in liquid form could be through use of spray, vapor, dipping and poring. Vetiver grass in powder or dust form embedded in cushioning of Mattress, cushions, pillows, padded seats, cloth and other bedding material. In addition, Use of Vetiver carpet or mat as sheet of mattress for prevention of bed bugs. This includes use of carpet between Mattress and box spring as a preventative measure.

3) Combining Vetiver oil with other material to enhance or control the effect of prevention, reduction or eradication of bed bugs in above described manner.
